(19) United States
(12) Patent Application Publication
(10) Pub. No.: US 2011/0110382 A1
(43) Pub. Date: May 12, 2011

(54) Distribution of Packets Among PortChannel Groups of PortChannel Links

(75) Inventors: Khalil A. Jabr, Oswego, OR (US); Sudhakar Shenoy, Karnataka (IN); Dileep K. Devireddy, San Jose, CA (US)

(73) Assignee: Cisco Technology, Inc., a corporation of California, San Jose, CA (US)

(21) Appl. No.: 12/645,564

(22) Filed: Dec. 23, 2009

(30) Foreign Application Priority Data
Nov. 10, 2009 (IN) 2320/DEL/2009

(51) Int. Cl. H04L 12/56

(52) U.S. Cl. 370/422

(57) ABSTRACT

PortChannel groups are disclosed which include multiple PortChannel links of a PortChannel. Further, the selection of a particular PortChannel group, and possibly a PortChannel link within a selected PortChannel group, for a packet is provided by user-programmable matching of programmed values or rules to data extracted from the packet. In this manner, the forwarding of packets over PortChannel groups can be explicit. Moreover, packets of different flows of a packet session can be caused to be forwarded over a same PortChannel group, possibly leading to a service node for performing one or more applications based on the packets of the flow(s) of a packet session.

### TECHNICAL FIELD

The present disclosure relates generally to communications systems.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). In trying to achieve these goals, a common approach taken by many communications providers is to use packet switching technology.

One means of increasing communication bandwidth between two devices is to distribute traffic across multiple physical links between the two devices. PortChannel (also referred to as EtherChannel) is a technology used in communications products of Cisco Systems, Inc. to aggregate multiple physical links into a single logical link with a single port interface. This aggregation allows customers to provide link redundancy, greater aggregated bandwidth, and automated load balancing. Additionally, each PortChannel has a single interface, which provides a single communications port for communicating over the multiple physical links.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 illustrates PortChannel groups according to one embodiment;

FIG. 2A illustrates a packet switching device operating according to one embodiment;

FIG. 2B illustrates using PortChannel groups according to one embodiment;

FIG. 3 illustrates an example system or component used in one embodiment;

FIG. 4 illustrates a process performed in one embodiment;

FIG. 5 illustrates a process performed in one embodiment; and

FIG. 6 illustrates a process performed in one embodiment.

### DESCRIPTION OF EXAMPLE EMBODIMENTS

### 1. Overview

Disclosed are, inter alia, methods, apparatus, computer-storage media, mechanisms, and means associated with distribution of packets among PortChannel groups of PortChannel links. One embodiment performs a method, with operations including: classifying, by a packet switching device, a packet to determine a particular PortChannel group of a plurality of PortChannel groups of a PortChannel of the packet switching device over which to send the packet, with said classifying operation including matching values within the packet to programmed rules or values, with the PortChannel including a plurality of PortChannel links, and with each of the plurality of PortChannel groups including at least one PortChannel link of the plurality of PortChannel links; and sending, by the packet switching device, the packet over a particular PortChannel link of said determined particular PortChannel group.

In one embodiment, the particular PortChannel group includes at least two of the plurality of PortChannel links; and wherein said operation of classifying the packet includes a second matching or hashing operation to determine the particular PortChannel from said at least two of the plurality of PortChannel links. In one embodiment, each of the plurality of PortChannel groups includes a single, different PortChannel link of the plurality of PortChannel links. One embodiment includes: deriving at least a portion of said program rules or values from instructions received in a user-specified access control list, user-defined policy, Common Classification Policy Language (C3PL), user-defined configuration parameters, or commands received via a command line interface.

In one embodiment, said PortChannel links of said particular PortChannel group are communicatively coupled to a particular service node configured for performing at least one application on a plurality of packet flows including a packet flow corresponding to the packet; wherein said operations of classifying and sending of the packet are performed for each packet of a plurality of packets; and wherein said operations include: identifying the plurality of packet flows based on the packet, and in response, updating said programmed rules or values to cause said classification operation performed on a subsequent plurality of packets of the plurality of packet flows to determine the particular PortChannel group; wherein the plurality of packets includes the subsequent plurality of packets. In one embodiment, said operation of identifying the plurality of packet flows based on the packet is performed by the service node.

### 2. Description

Disclosed are, inter alia, methods, apparatus, computer-storage media, mechanisms, and means associated with distribution of packets among PortChannel groups of PortChannel links. “PortChannel” is technology that provides a device bandwidth aggregation of multiple physical links or paths (e.g., sub-channels, tunnels, etc.), while presenting a single port interface for all of these links to the device. By providing a single port interface, a PortChannel does not expose higher-level protocols to the different paths that packets may take through the links associated with the Port Channel. For example, a Reverse Path Forwarding (RPF) check will work on packets received on PortChannel no matter the link over which the packet traveled, but may result in the packet being dropped if each of the multiple links were represented to the device as separate ports. Note, the term “PortChannel link” refers to the individual physical link or individual path through the multiple physical links used by the PortChannel. The term “PortChannel group” refers to a set of one or more PortChannel links.

Embodiments described herein include various elements and limitations, with no one element or limitation contemplated as being a critical element or limitation. Each of the claims individually recites an aspect of the invention in its entirety. Moreover, some embodiments described may include, but are not limited to, inter alia, systems, networks, integrated circuit chips, embedded processing elements, ASICs, methods, and computer-readable media containing instructions. The embodiments described hereinafter embody various aspects and configurations within the scope and spirit of the invention, with the figures illustrating exemplary and non-limiting configurations. Note, computer-readable media and means for performing methods and processing block operations are disclosed and are in keeping with the extensible scope and spirit of the invention.

Note, the steps, connections, and processing of signals and information illustrated in the figures, including, but not limited to any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value—the value must be obtained prior to processing it, although some of the associated processing may be performed prior to, concurrently with, and/or after the read operation).

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although any embodiment may include some, all or none of the features, elements and/or limitations described in relation to a particular different one embodiment. In addition, the terms “first,” “second,” etc. are typically used herein to denote different units (e.g., a first element, a second element). The use of these terms herein does not necessarily connote an ordering such as one unit or event occurring or coming before another, but rather provides a mechanism to distinguish between particular units. Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps. Note, nothing described or referenced in this document is admitted as prior art to this application unless explicitly so stated.

Disclosed are, inter alia, methods, apparatus, computer-storage media, mechanisms, and means associated with distribution of packets among PortChannel groups of PortChannel links. One embodiment includes an apparatus, comprising: a plurality of PortChannel groups of a PortChannel, with each said PortChannel group including one or more PortChannel links of a plurality of PortChannel links configured for sending packets; and one or more PortChannel distribution engines configured for determining from which particular PortChannel group to send each particular packet of a plurality of packets; wherein said determination includes matching values within said particular packet to programmed rules or values.

In one embodiment, each of the plurality of PortChannel groups includes a single, different PortChannel link of the plurality of PortChannel links. In one embodiment, at least one PortChannel group of the plurality of PortChannel groups includes at least two of the plurality of PortChannel links; and wherein said one or more PortChannel distribution engines are configured to perform a second matching or hashing operation to determine a particular PortChannel within the particular PortChannel group from which to send said particular packet. One embodiment includes a particular service node configured for performing at least one application on a plurality of packet flows corresponding to a received packet; wherein the particular service node is communicatively coupled to one or more of the plurality of PortChannel links of a specific PortChannel group of the plurality of PortChannel groups, such that packets sent from the specific PortChannel group are received by the particular service node; and wherein the apparatus is configured to identify the plurality of packet flows based on the received packet, and in response, to update said programmed rules or values to cause said one or more PortChannel distribution engines to determine the specific PortChannel group for subsequent packets belonging to the plurality of packet flows. In one embodiment, the particular service node is configured for identifying updates to said programmed rules or values to cause said one or more PortChannel distribution engines to determine the specific PortChannel group for subsequent packets belonging to the plurality of packet flows. In one embodiment, each of the plurality of PortChannel groups includes a single, different PortChannel link of the plurality of PortChannel links. In one embodiment, the specific PortChannel group includes at least two of the plurality of PortChannel links. One embodiment comprises a processing element configured for deriving at least a portion of said program rules or values from instructions received in a user-specified access control list, user-defined policy, Common Classification Policy Language (C3PL), user-defined configuration parameters, or commands received via a command line interface. In one embodiment, the apparatus of claim 4, wherein the apparatus is a packet switching device. One embodiment comprises a processing element configured for deriving at least a portion of said program rules or values from instructions received in a user-specified access control list, user-defined policy, Common Classification Policy Language (C3PL), user-defined configuration parameters, or commands received via a command line interface.

One embodiment includes a method, comprising: classifying, by a packet switching device, a packet to determine a particular PortChannel group of a plurality of PortChannel groups of a PortChannel of the packet switching device over which to send the packet, with said classifying operation including matching values within the packet to programmed rules or values, with the PortChannel including a plurality of PortChannel links, and with each of the plurality of PortChannel groups including at least one PortChannel link of the plurality of PortChannel links; and sending, by the packet switching device, the packet over a particular PortChannel link of said determined particular PortChannel group. In one embodiment, the particular PortChannel group includes at least two of the plurality of PortChannel links; and wherein said operation of classifying the packet includes a second matching or hashing operation to determine the particular PortChannel from said at least two of the plurality of PortChannel links. In one embodiment, each of the plurality of PortChannel groups includes a single, different PortChannel link of the plurality of PortChannel links. In one embodiment, said PortChannel links of said particular PortChannel group are communicatively coupled to a particular service node configured for performing at least one application on a plurality of packet flows including a packet flow corresponding to the packet; wherein said operations of classifying and sending of the packet are performed for each packet of a plurality of packets; and wherein said operations include: identifying the plurality of packet flows based on the packet, and in response, updating said programmed rules or values to cause said classification operation performed on a subsequent plurality of packets of the plurality of packet flows to determine the particular PortChannel group; wherein the plurality of packets includes the subsequent plurality of packets. In one embodiment, said operation of identifying the plurality of packet flows based on the packet is performed by the service node. In one embodiment, each of the plurality of PortChannel groups includes a single, different PortChannel link of the plurality of PortChannel links. One embodiment includes: deriving at least a portion of said program rules or values from instructions received in a user-specified access control list, user-defined policy, Common Classification Policy Language (C3PL), user-defined configuration parameters, or commands received via a command line interface.

One embodiment includes an apparatus, comprising: mean for classifying a packet to determine a particular PortChannel group of a plurality of PortChannel groups of a PortChannel of the apparatus over which to send the packet, with said classifying operation including matching values within the packet to programmed rules or values, with the PortChannel including a plurality of PortChannel links, and with each of the plurality of PortChannel groups including at least one PortChannel link of the plurality of PortChannel links; and means for sending, by the packet switching device, the packet over a particular PortChannel link of said determined particular PortChannel group. In one embodiment, each of the plurality of PortChannel groups includes a single, different PortChannel link of the plurality of PortChannel links.

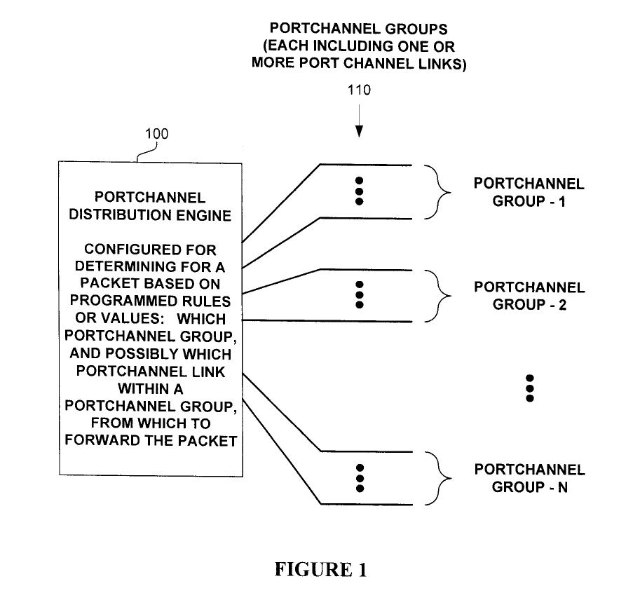

FIG. 1 illustrates PortChannel groups 110 according to one embodiment. “PortChannel” is technology that provides a device bandwidth aggregation of multiple physical links or paths (e.g., sub-channels, tunnels, etc.), while presenting a single port interface for all of these links to the device. By providing a single port interface, a PortChannel does not expose higher-level protocols to the different paths that packets may take through the links associated with the Port Channel. This further allows traffic engineering, typically, without making changes to the higher-level protocols nor to functions, such as, but not limited to routing protocol(s) or the multicast control plane. Note, the term “PortChannel link” refers to the individual physical link or individual path through the multiple physical links used by the PortChannel. The term “PortChannel group” refers to a set of one or more PortChannel links.

Shown in FIG. 1 is PortChannel distribution engine 100 configured for distributing packets to PortChannel Groups 110, with each PortChannel Group (110) including one or more PortChannel links. PortChannel distribution engine 100 is configured to determine over which PortChannel groups 110, and possibly further determine over which PortChannel link within a PortChannel group (110), to forward a particular packet. PortChannel engine 100 is programmed with a set of rules or values which are used to match (e.g., direct matching, signature detection, etc.) against a packet to first determine a corresponding one of the PortChannel Groups 110. If this determined PortChannel Group (110) includes multiple PortChannel links, then, in one embodiment, a second matching operation or hashing operation (e.g., based on one or more fields of the packet) is performed, typically automatically such as to load balance or based on a specified user policy, to identify a PortChannel link within the determined PortChannel group. PortChannel distribution engine 100 then forwards (e.g., actually forwards or causes to be forwarded) the packet accordingly from the determined PortChannel group (e.g., over the single PortChannel link of the PortChannel Group, or over the determined PortChannel link of the PortChannel group).

In one embodiment, at least a portion of the program rules or values are derived from instructions received in a user-specified access control list, user-defined policy, Common Classification Policy Language (C3PL), user-defined configuration parameters, or commands received via a command line interface. In this manner, the selection of a PortChannel group is responsive to a user policy, but the user policy can specify particular values, not merely which fields on which to base a hashing operation to determine the PortChannel link from which to send a packet. For example, such matching operations could use: Differentiated Services Code Point (DSCP) values (e.g., Quality of Service, priority), Layer-4 (e.g., application) values, source and destination addresses and port numbers, protocol type, Layer 2 addresses or other values, and/or even values extracted from the packet based on deep packet inspection.

For example, assume that a PortChannel includes two PortChannel groups, and it is desired to use a first one for a first application and the second one for a second application. The PortChannel distributor (or simply the packet switching device) can be programmed to ensure packets are forwarded over the PortChannel groups accordingly. In contrast, prior systems simply used a hash function to load balance the packet traffic over the PortChannel links (as well as having no concept of a PortChannel group including multiple Port Channel links). Although one prior system allowed a user to select which fields of a packet would be used by the hash function, such system was not capable of programming specifying a particular PortChannel link (nor PortChannel group) to be used for a matching packet.

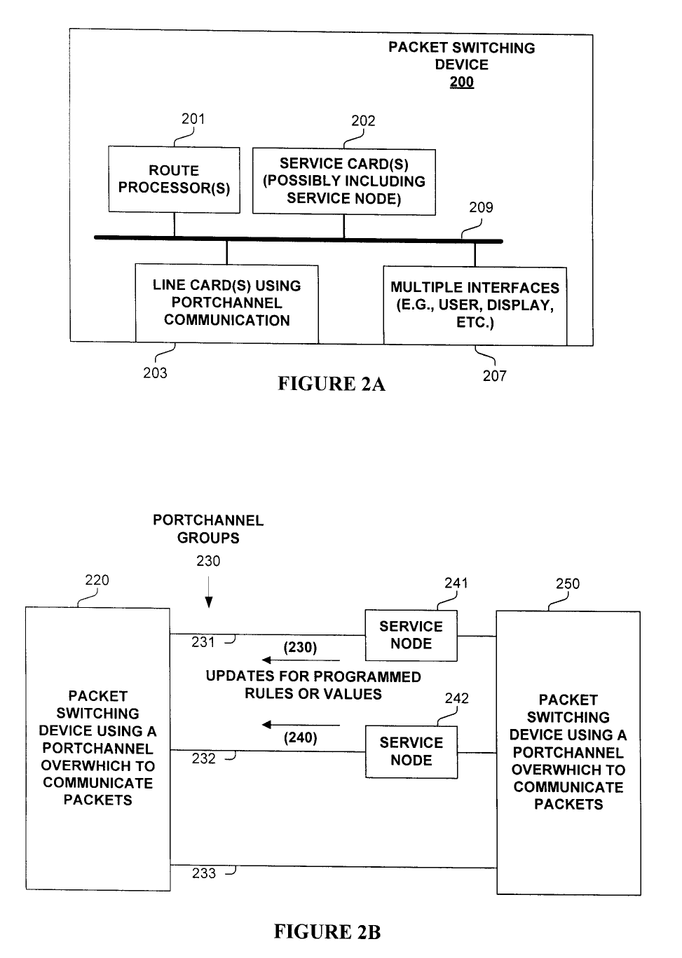

FIG. 2A illustrates a packet switching device 200 operating according to one embodiment. As shown, packet switching device 200 includes one or more route processors 201, one or more service cards 202 (which may or may not include one or more service nodes), one or more interface(s) 207 (e.g., user-interfaces, displaying information, etc.), and one or more line cards 207 using PortChannel communication (i.e., including using PortChannel groups as disclosed herein).

FIG. 2B illustrates using PortChannel groups 230 according to one embodiment. As shown, packet switching device (e.g., router, switch) 220 uses a PortChannel, including multiple PortChannel groups 230, to communicate packets with packet switching device 250. In this example, PortChannel groups 230 include the three PortChannel groups 231, 232, and 233. (Of course, other embodiments may use the same or a different number of PortChannel groups.)

In this example, the PortChannel links of PortChannel Group 231 are communicatively coupled to service node 241; and the PortChannel links of PortChannel Group 232 are communicatively coupled to service node 242. Each service node 241 and 242 typically perform some application on packets sent through them. It is important (and typically required) that packets of a same session, be routed to the same service node 241 or 242. Moreover, a session can include multiple flows of packets. Consider the FTP session as an example. For example, a File Transfer Protocol (FTP) session includes a control channel (flow) and a data channel (flow). Control channel packets build the state for the data channel. If control channel packets are sent to one service node and data channel packets to another service node, then they can't process the session as each one has partial state. (Note, typically, a flow for IPv4 is defined by the five-tuple of source address, destination address, source port, destination port, and protocol type.)

Therefore, packets of every flow of a session being serviced by service node 241 must be forwarded over the same PortChannel Group 231, and packets of every flow of a session being serviced by service node 242 must be forwarded over the same PortChannel Group 232. The capability of matching programmed rules or values allows such control of forwarding packets over particular PortChannel groups (and possibly individual PortChannel links within a PortChannel group). Furthermore, in one embodiment, each of service nodes 241 and 242 is configured to cause updates (230, 240) to the programming for distributing packets to PortChannel groups to cause packets of one or more flows associated with a received packet to be sent over the same PortChannel group.

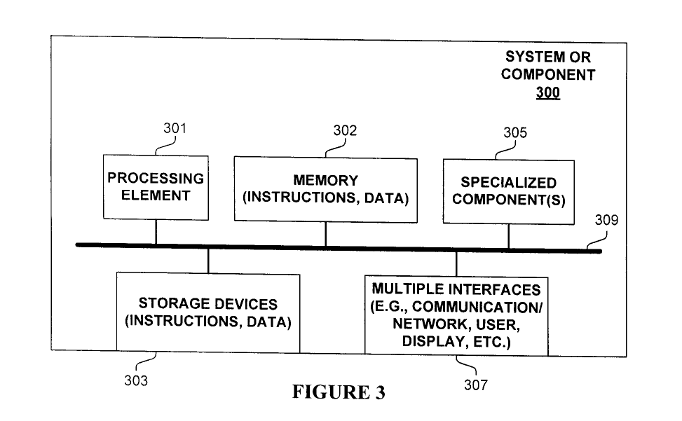

FIG. 3 is block diagram of a system or component 300 (including a partial design implemented in an ASIC) used in one embodiment associated with the forwarding of packets based on a filtered Forwarding Information Base (FIB). In one embodiment, system or component 300 performs one or more processes or operations thereof, corresponding to one of the flow, block or other diagrams illustrated or otherwise described herein.

In one embodiment, system or component 300 includes a processing element 301, memory 302, storage devices 303, specialized components 305 (e.g. optimized hardware such as for performing matching value(s) or rules such as a content-addressable memory, a pattern matching device, etc.), and interface(s) 307 for communicating information (e.g., sending and receiving packets, user-interfaces, displaying information, etc.), which are typically communicatively coupled via one or more communications mechanisms 309, with the communications paths typically tailored to meet the needs of the application.

Various embodiments of component 300 may include more or less elements. The operation of component 300 is typically controlled by processing element 301 using memory 302 and storage devices 303 to perform one or more tasks or processes. Memory 302 is one type of computer-readable/computer-storage medium, and typically comprises random access memory (RAM), read only memory (ROM), flash memory, integrated circuits, and/or other memory components. Memory 302 typically stores computer-executable instructions to be executed by processing element 301 and/or data which is manipulated by processing element 301 for implementing functionality in accordance with an embodiment. Storage devices 303 are another type of computer-readable medium, and typically comprise solid state storage media, disk drives, diskettes, networked services, tape drives, and other storage devices. Storage devices 303 typically store computer-executable instructions to be executed by processing element 301 and/or data which is manipulated by processing element 301 for implementing functionality in accordance with an embodiment.

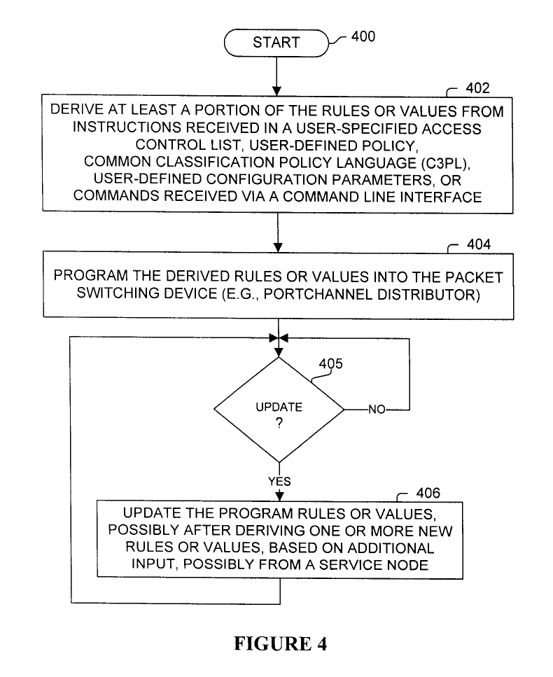

FIG. 4 illustrates a process performed in one embodiment. Processing beings with process block 400. In process block 402, at least a portion of the rules or values to be programmed are derived from instructions received in a user-specified access control list, user-defined policy, Common Classification Policy Language (C3PL), user-defined configuration parameters, or commands received via a command line interface. In process block 404, the derived rules or values are programmed into the packet switching device (e.g., into the PortChannel distributor in one embodiment). As determined in process block 405, when there is an update to be made to the programmed rules (e.g., in response to new user input, or based on information received from a service node), then in process block 406, the program rules or values are updated, possibly after deriving one or more new rules or values, based on additional input, possibly from a service node. Processing returns to process block 405 to wait for an additional update, if any.

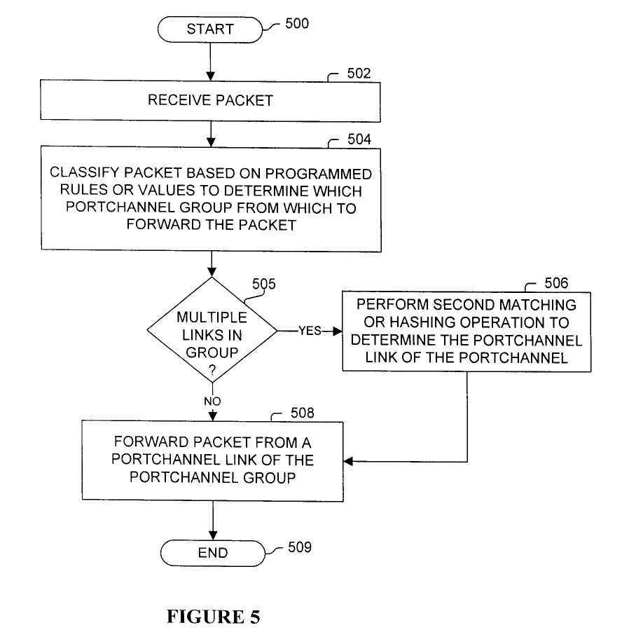

FIG. 5 illustrates a process, performed in one embodiment, by a packet switching device (e.g., router, switch). Processing begins with process block 500. In process block 502, a packet is received. In process block 504, the packet is classified based on programmed rules or values (e.g., matching value(s) extracted from packets, signature detection, etc.) to determine which PortChannel group from which to forward the packet. As determined in process block 505, if there are multiple PortChannel links within the determined PortChannel group, then a second matching operation (e.g., on programmed rules or values) or hashing operation (e.g., based on one or more fields of the packet, such as to balance the load across the PortChannel links) is performed in process block 506 to identify the particular PortChannel link in the determined PortChannel group. This identification of the particular PortChannel link is based on a user policy in one embodiment, and automatically selected in one embodiment. (Note, a PortChannel group may consist of a single PortChannel link; and therefore, identification of the PortChannel group identifies the PortChannel link for sending the packet.) In process block 508, the packet is forwarded from a PortChannel link of the PortChannel group. Processing of the flow diagram of FIG. 5 is complete as indicated by process block 509.

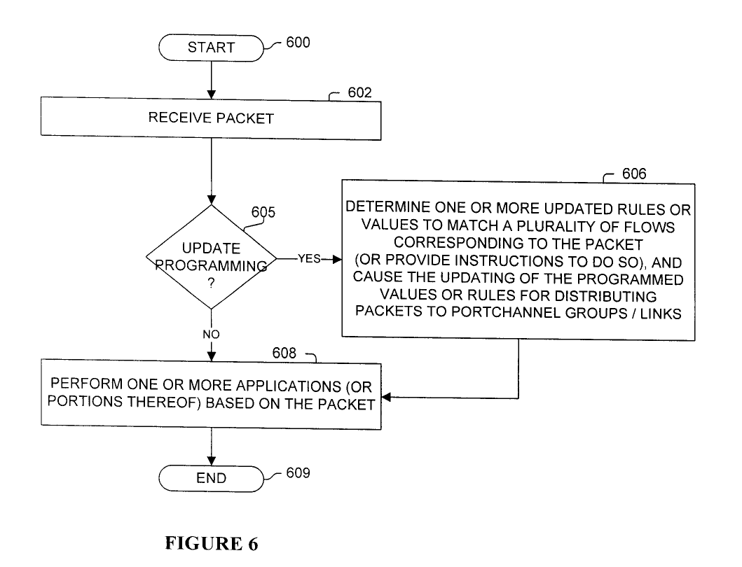

FIG. 6 illustrates a process, performed in one embodiment, by a service node. Processing begins with process block 600. In process block 602, a packet is received. As determined in process block 605, if the programming of the distribution of packets among PortChannel groups, and possibly PortChannel links within one or more PortChannel groups, need updating, then process block 606 is performed. Therein, one or more updated rules or values to match multiple flows corresponding to the packet (e.g., part of a packet session associated with the packet) are determined (or instructions for the packet switching device to do so are determined) which will cause related packets (e.g., of a same packet session) to be forwarded to the service node. The service node communicates these updated rules, values and/or instructions to the packet switching device to cause the updating of the programmed rules for distributing packets among the PortChannel groups, and possibly PortChannel links within PortChannel groups. In process block 608, one or more applications (or portions thereof) are typically performed based on the packet. Processing of the flow diagram of FIG. 6 is complete as indicated by process block 609.

In view of the many possible embodiments to which the principles of our invention may be applied, it will be appreciated that the embodiments and aspects thereof described herein with respect to the drawings/figures are only illustrative and should not be taken as limiting the scope of the invention. For example, and as would be apparent to one skilled in the art, many of the process block operations can be re-ordered to be performed before, after, or substantially concurrent with other operations. Also, many different forms of data structures could be used in various embodiments. The invention as described herein contemplates all such embodiments as may come within the scope of the following claims and equivalents thereof.

What is claimed is:

1. An apparatus, comprising:
a plurality of PortChannel groups of a PortChannel, with each said PortChannel group including one or more PortChannel links of a plurality of PortChannel links configured for sending packets; and
one or more PortChannel distribution engines configured for determining from which particular PortChannel group to send each particular packet of a plurality of packets; wherein said determination includes matching values within said particular packet to programmed rules or values.

2. The apparatus of claim 1, wherein each of the plurality of PortChannel groups includes a single, different PortChannel link of the plurality of PortChannel links.

3. The apparatus of claim 1, wherein at least one PortChannel group of the plurality of PortChannel groups includes at least two of the plurality of PortChannel links; and wherein said one or more PortChannel distribution engines are configured to perform a second matching or hashing operation to determine a particular PortChannel within the particular PortChannel group from which to send said particular packet.

4. The apparatus of claim 1, including a particular service node configured for performing at least one application on a plurality of packet flows corresponding to a received packet; wherein the particular service node is communicatively coupled to one or more of the plurality of PortChannel links of a specific PortChannel group of the plurality of PortChannel groups, such that packets sent from the specific PortChannel group are received by the particular service node; and
wherein the apparatus is configured to identify the plurality of packet flows based on the received packet, and in response, to update said programmed rules or values to cause said one or more PortChannel distribution engines to determine the specific PortChannel group for subsequent packets belonging to the plurality of packet flows.

5. The apparatus of claim 4, wherein the particular service node is configured for identifying updates to said programmed rules or values to cause said one or more PortChannel distribution engines to determine the specific PortChannel group for subsequent packets belonging to the plurality of packet flows.

6. The apparatus of claim 4, wherein each of the plurality of PortChannel groups includes a single, different PortChannel link of the plurality of PortChannel links.

7. The apparatus of claim 4, wherein the specific PortChannel group includes at least two of the plurality of PortChannel links.

8. The apparatus of claim 4, comprising a processing element configured for deriving at least a portion of said program rules or values from instructions received in a user-specified access control list, user-defined policy, Common Classification Policy Language (C3PL), user-defined configuration parameters, or commands received via a command line interface.

9. The apparatus of claim 4, wherein the apparatus is a packet switching device.

10. The apparatus of claim 1, comprising a processing element configured for deriving at least a portion of said program rules or values from instructions received in a user-specified access control list, user-defined policy, Common Classification Policy Language (C3PL), user-defined configuration parameters, or commands received via a command line interface.

11. The apparatus of claim 1, wherein the apparatus is a packet switching device.

12. A method, comprising:
classifying, by a packet switching device, a packet to determine a particular PortChannel group of a plurality of PortChannel groups of a PortChannel of the packet switching device over which to send the packet, with said classifying operation including matching values within the packet to programmed rules or values, with the PortChannel including a plurality of PortChannel links, and with each of the plurality of PortChannel groups including at least one PortChannel link of the plurality of PortChannel links; and
sending, by the packet switching device, the packet over a particular PortChannel link of said determined particular PortChannel group.

13. The method of claim 12, wherein the particular PortChannel group includes at least two of the plurality of PortChannel links; and wherein said operation of classifying the packet includes a second matching or hashing operation to determine the particular PortChannel from said at least two of the plurality of PortChannel links.

14. The method of claim 12, wherein each of the plurality of PortChannel groups includes a single, different PortChannel link of the plurality of PortChannel links.

15. The method of claim 12, wherein said PortChannel links of said particular PortChannel group are communicatively coupled to a particular service node configured for performing at least one application on a plurality of packet flows including a packet flow corresponding to the packet; wherein said operations of classifying and sending of the packet are performed for each packet of a plurality of packets; and wherein said operations include: identifying the plurality of packet flows based on the packet, and in response, updating said programmed rules or values to cause said classification operation performed on a subsequent plurality of packets of the plurality of packet flows to determine the particular PortChannel group; wherein the plurality of packets includes the subsequent plurality of packets.

16. The method of claim 15, wherein said operation of identifying the plurality of packet flows based on the packet is performed by the service node.

17. The method of claim 15, wherein each of the plurality of PortChannel groups includes a single, different PortChannel link of the plurality of PortChannel links.

18. The method of claim 12, comprising: deriving at least a portion of said program rules or values from instructions received in a user-specified access control list, user-defined policy, Common Classification Policy Language (C3PL), user-defined configuration parameters, or commands received via a command line interface.

19. An apparatus, comprising:
mean for classifying a packet to determine a particular PortChannel group of a plurality of PortChannel groups of a PortChannel of the apparatus over which to send the packet, with said classifying operation including matching values within the packet to programmed rules or values, with the PortChannel including a plurality of PortChannel links, and with each of the plurality of PortChannel groups including at least one PortChannel link of the plurality of PortChannel links; and
means for sending, by the packet switching device, the packet over a particular PortChannel link of said determined particular PortChannel group.

20. The apparatus of claim 20, wherein each of the plurality of PortChannel groups includes a single, different PortChannel link of the plurality of PortChannel links.
